(19) United States
(12) Patent Application Publication
(10) Pub. No.: US 2007/0128012 A1
(43) Pub. Date: Jun. 7, 2007

(54) Industrial vehicle having working implement

(76) Inventors: Masami Yamada, Kariya-shi (JP); Koichiro Mori, Kariya-shi (JP); Masami Sakamoto, Kariya-shi (JP)

Correspondence Address: MORGAN & FINNEGAN, L.L.P., 3 World Financial Center, New York, NY, 10281-2101, US

(21) Appl. No.: 11/634,017

(22) Filed: Dec. 4, 2006

(30) Foreign Application Priority Data
Dec. 6, 2005 (JP) 2005-351463

(51) Int. Cl. B66C 23/00

(52) U.S. Cl. 414/685; 414/700

(57) ABSTRACT

An industrial vehicle has a frame, a lift arm, a working Implement, a front link, a rear link and a lift cylinder. The lift arm has a front end. The working implement is mounted to the front end of the lift arm. The front link is pivotally connected at one end to the lift arm and at the other end to the frame at a first connecting position. The rear link is pivotally connected at one end to the lift arm and at the other end to the frame at a second connecting position. The lift cylinder is pivotally connected at one end to the lift arm and at the other end to the frame at a third connecting position. The first connecting position, the second connecting position and the third connecting position are located at substantially the same level.

### BACKGROUND OF THE INVENTION

The present invention relates to an industrial vehicle having a working implement, such as a skid steer loader, which is operable to raise and lower a working implement in a substantially vertical path.

A skid steer loader, which is one of Industrial vehicles, is disclosed, for example, in U.S. Pat. No. 6,474,933. This skid steer loader is operable to raise a bucket (corresponding to a working tool or implement) mounted to the forward ends of right and left booms (corresponding to right and left lift arms) in a substantially vertical path. Each of the booms is mounted to the main frame of the skid steer loader through respective front control link, rear boom support link and hydraulic cylinder. Such skid steer loaders are disclosed in the U.S. Pat. No. 6,616,398, U.S. Pat. No. 6,796,762 and. U.S. Pat. No. 5,609,464.

In the U.S. Pat. No. 6,474,933, the connecting portions between right and left hydraulic cylinders and the main frame of a loader (indicated by the reference numeral 58 in FIG. 2) are located rearward of rear wheels and lower than the upper ends of the rear wheels, and the hydraulic cylinders are considerably long. Thus, it is difficult for the above loader to ensure the strength of the support for the boom and, therefore, such loader is not applicable to handling heavy loads. Furthermore, the arrangement of the control link, the boom support link and the hydraulic cylinder on each side looks disorderly and the appearance of the side of the vehicle is poor. Moreover, any component part provided in the space behind the rear wheels would interfere with the cylinder (or the range in which the hydraulic cylinder Is turned when the boom is raised or lowered) and, therefore, no part can be provided in the space.

Similarly, in the U.S. Pat. No. 6,616,398 disclosing a lift boom assembly, the pivotal proximal portions of its long hydraulic actuators (corresponding to hydraulic cylinders) are arranged rearward of rear wheels and lower than the upper end of the rear wheels. Thus, it is also difficult for this lift boom assembly to ensure the strength of the support for its lift arm assemblies, and the appearance of the lift arm assemblies is disorderly and hence poor. Furthermore, it is difficult to make a space rearward of the rear wheels for arrangement of vehicle components.

In the U.S. Pat. No. 6,796,762 disclosing a skid steer loader, the connecting portions between right and left rear links and lift cylinders and a frame are located rearward of the rear wheels and lower than the upper end of the rear wheels. Thus, as In the case of the U.S. Pat. No. 6,474,933 and the U.S. Pat. No. 6,616,398, there Is also a hindrance to ensuring the strength of the support for lift arms, to Improvement in design of the appearance and also to the degree of freedom in arrangement of vehicle components. Furthermore, an arm, a rear link and a lift cylinder are arranged laterally on each side of the vehicle between its frame and the front and rear wheels, with the result that the widthwise cabin space, or operator's compartment, is narrowed accordingly. The U.S. Pat. No. 5,609,464 and the U.S. Pat. No. 6,796,762 have the same problem.

### SUMMARY OF THE INVENTION

In accordance with the present invention, an industrial vehicle has a frame, a lift arm, a working implement, a front link, a rear link and a lift cylinder. The lift arm has a front end. The working implement is mounted to the front end of the lift arm. The front link is pivotally connected at one end to the lift arm and at the other end to the frame at a first connecting position. The rear link is pivotally connected at one end to the lift arm and at the other end to the frame at a second connecting position. The lift cylinder is pivotally connected at one end to the lift arm and at the other end to the frame at a third connecting position. The first connecting position, the second connecting position and the third connecting position are located at substantially the same level.

Other aspects and advantages of the Invention will become apparent from the following description, taken In conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a side view of a skid steer loader according to a preferred embodiment of the present invention;

FIG. 2 is a perspective view of the skid steer loader as seen from the left posterosuperior of the skid steer loader;

FIG. 3 is a side view of the skid steer loader, showing a first half of load raising operation; and

FIG. 4 is a side view of the skid steer loader, showing a second half of load raising operation.

### DETAILED DESCRIPTION OF THE PREFERRED EMBODIMENTS

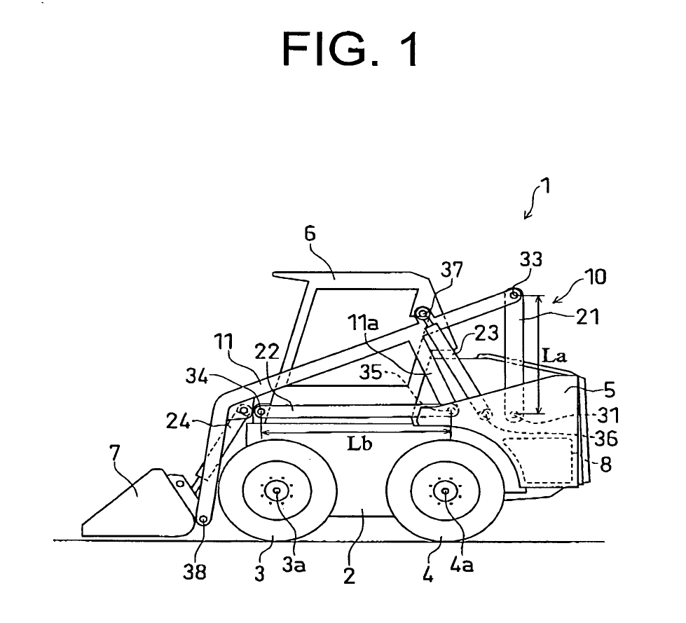

The following will describe a preferred embodiment of an industrial vehicle, such as a skid steer loader, according to the present Invention with reference to FIGS. 1 through 4.

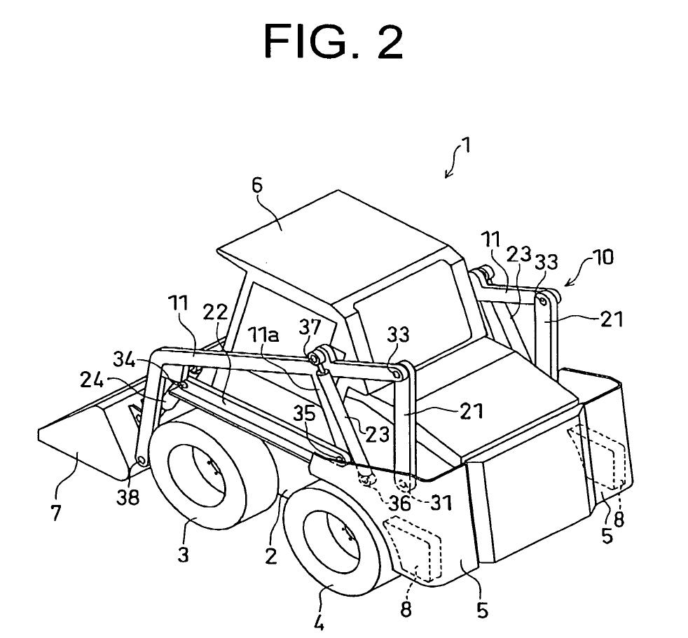

Referring to FIGS. 1 and 2, the industrial vehicle or the skid steer loader 1 includes a frame 2, front and rear pairs of wheels 3 and 4 mounted to the frame 2 and an engine (not shown) mounted in the frame 2 for driving the wheels 3 and 4. The frame 2 has a lower section which is made robust for accommodating therein a chain box (not shown), or the like, for driving the front and rear pairs of wheels 3, 4. A cabin 6 in which an operator's seat disposed is mounted on the frame 2 adjacent to its front and the engine and counterweight 8 are mounted to the rear of the frame 2.

The skid steer loader 1 has a pair of right and left lift arms 11 which are operable to be raised and lowered. A pivotable bucket 7, or a working implement, is mounted through pins 38 between the front ends of the right and left lift arms 11. The lift arms 11 of this embodiment is of double-arm type in which the paired arms 11 are mounted such that the cabin 6 is flanked by the arms 11, as shown in FIG. 2.

Each lift arm 11 is arranged just above the respective front and rear wheels 3, 4, that is, the lift arms 11 of each pair are spaced laterally at substantially the same distance as the front and rear wheels 3, 4. Referring to FIGS. 1 and 2 in which the lift arms 11 are located at their fully lowered position, each lift arm 11 extends just over the wheels 3, 4 forwardly downward and then bends sharply to extend downward. The front end of each lift arm 11 is located adjacent to the front wheel 3.

A bucket cylinder 24 is provided near the front end of each lift arm 11 for pivoting the bucket 7. The lift arms 11 are movable to be raised and lowered by a raising and lowering device 10.

Supports 5 are mounted to the rear of the frame 2 of the skid steer loader 1 on opposite sides, and rear links 21 are pivotally connected at the lower ends thereof to the supports 5 through pins 31, respectively. The connecting positions or the pins 31 of the rear links 21 are located rearward of the rear axle 4a of the vehicle In plan view. The rear links 21 are also pivotally connected at the upper ends thereof to the proximal ends (or the rear ends) of the lift arms 11 through pins 33.

Front links 22 are arranged on opposite sides of the vehicle and pivotally connected at the front ends thereof to the front of the frame 2 through pins 34. On the other hand, the front links 22 are pivotally connected at the rear ends thereof through pins 35 to the lower ends of downward extending portions 11a of the lift arms 11 which are formed adjacent to the proximal ends of the lift arms 11. It is noted that the length La of the rear link 21 is half of the length Lb of the front link 22 or greater (i.e. La≧Lb/2).

The lift cylinders 23 are pivotally connected at the proximal ends thereof to the supports 5 through pins 36. The connecting position at the pin 36 of each lift cylinder 23 is located adjacent to the position at the pin 31 through which the rear link 21 Is connected to the frame 2. On the other hand, the lift cylinders 23 are pivotally connected at the rod end thereof through pins 37 to a position adjacent to the proximal portion of the downward extending portion 11a of the lift arm 11.

As clearly shown in FIG. 1, the position of the pin 34 (or a first connecting position) at which the front link 22 is connected to the frame 2, the position of the pin 31 (or a second connecting position) at which the rear link 21 is connected to the frame 2 and the position of the pin 36 (or a third connecting position) at which the lift cylinder 23 Is connected to the frame 2 are located at substantially the same level. Additionally, the positions of these three pins 34, 31, 36 are located higher than the upper ends of the front and rear wheels 3, 4.

As a result of the above arrangement, none of the links 21, 22 and lift cylinders 23 are mounted to the supports 5 at a position just rearward of the rear wheels 4, so that a component or member if any mounted in the area at the above position will not interfere with the pivotal areas of the links 21, 22 and the lift cylinders 23. Thus, the above area may be efficiently used for mounting any other component.

As shown in FIGS. 1 and 2, in this embodiment, the counterweight 8 is arranged at the above position which is lower than the connecting positions of the links 21, 22 and the lift cylinder 23 to the frame 2 and just rearward of the rear wheels 4. The counterweight 8 is arranged within the respective supports 5. A position rearward of the rear wheel 4 is considerably remote from the front axle 3a, which is a tumble axis, so that the arrangement of the counterweight 8 at this position greatly improves the stability of the skid steer loader 1 in its longitudinal direction.

Alternatively, in place of the counterweight 8, a fuel tank for reserving engine fuel, an oil tank for reserving hydraulic fluid used for operating hydraulic actuators such as the lift cylinder 23 or a battery may be provided in the area at the above position. Thus, the degree of freedom In arrangement of any components of the skid steer loader 1 Is improved, so that the structure of the vehicle 1 will be simple and compact. Furthermore, arrangement of a heavy load such as a fuel tank, an oil tank and a battery at the above position allows such heavy load to serve as a counterweight.

As shown in FIG. 2, the paired lift arms 11, lift cylinders 23, front links 22 and rear links 21 are mounted on opposite sides of the vehicle, respectively, and the components 11, 23, 22, 21 of each pair are spaced laterally at substantially the same distance as the paired front and rear wheels 3, 4.

Each lift cylinder 23 Is a fluid pressure cylinder, specifically, a hydraulic cylinder, connected to a hydraulic pressure supply means, such as an oil pump driven by the engine (not shown), through a control valve, such as an electromagnetic valve (not shown). This control valve is adapted to be opened and closed by a microcomputer-type controller (not shown). In this embodiment, the raising and lowering device 10 for each lift arm 11 includes at least the lift cylinder 23, the front link 22 and the rear link 21.

The following will describe the operation of the raising and lowering device 10 during load raising operation. When the lift arms 11 are at their lowered position as shown in FIGS. 1 and 2, the lift cylinders 23 are sufficiently retracted and the front links 22 are positioned in a substantially horizontal manner, extending rearward as seen from the pins 34. The rear links 21 are then positioned in a substantially vertical manner, extending upward as viewed from the pins 31.

In this state, as the operator seated on the operator's seat inside the cabin 6 manipulates any operating means (not shown), such as a lever and a pedal, the lift cylinders 23 are supplied with oil under pressure and operated to extend, thereby causing the front links 22 to pivot toward its upright position and the lift arms 11 to move upward.

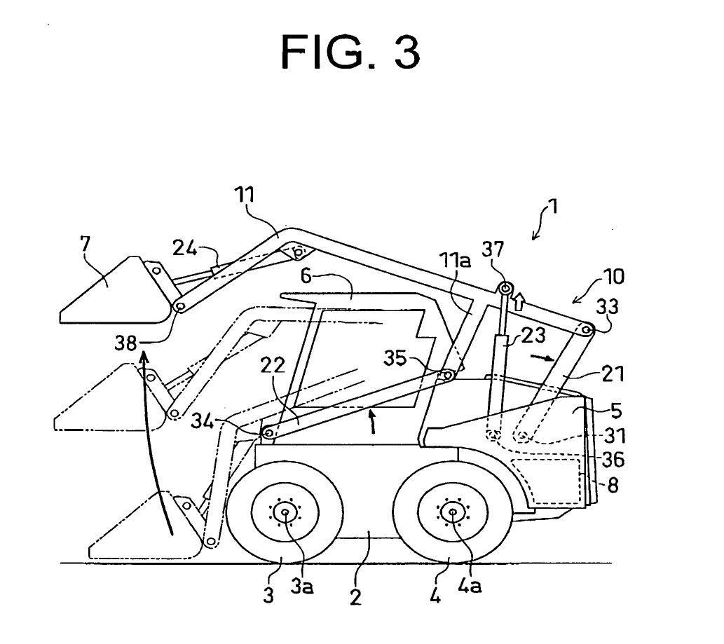

In the initial stage of the load raising operation, while the lift arms 11 are being raised, the rear links 21 pivot rearward about the pins 31 thereby to make the proximal ends of the lift arms 11 move rearward, as shown In FIG. 3. Thus, the bucket 7 provided at the front ends of the lift arms 11 is moved rearward, accordingly. As a result, the front ends of the lift arms 11 are moved generally along a substantially linear path during the initial period of load raising operation as indicated by the upward arrow in FIG. 3, although the path is just slightly curved forward.

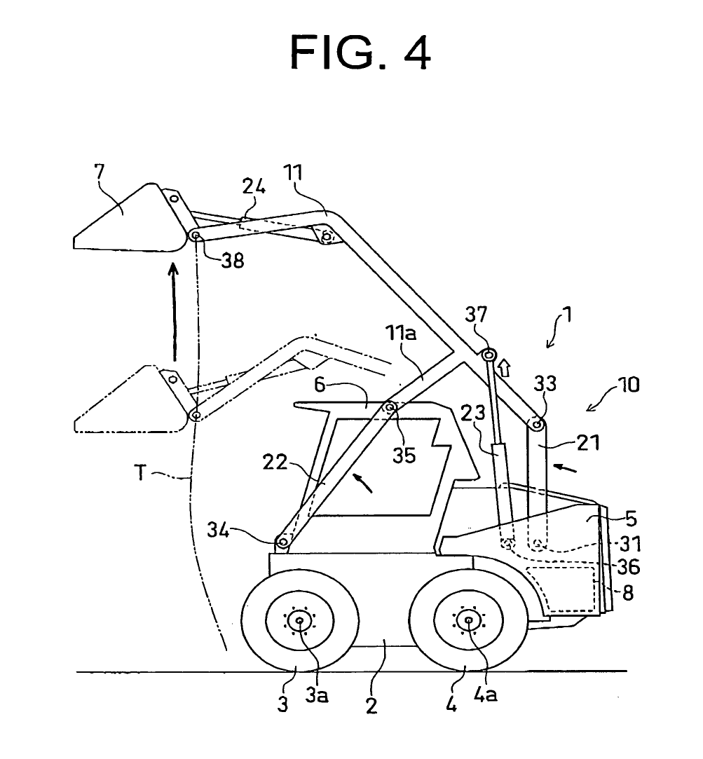

After the lift cylinders 23 has extended to an extent that the front ends of the lift arms 11 are located substantially at the middle level (that is at the level of the pin 33), the rear links 21 then pivot in the reverse direction about the pins 31, as shown in FIG. 4, while the bucket 7 is being further raised. Accordingly, the proximal ends of the lift arms 11 move forwardly upward. Therefore, when the lift arms 11 and the bucket 7 at the front ends of the lift arms 11 are being raised, they are moved slightly forward.

Consequently, the lift arms 11 reach their fully raised position which is indicated by solid line in FIG. 4, where the desired forward reach of the front ends of the lift arms 11 is ensured.

As described above, in the skid steer loader 1 according to the preferred embodiment, the front ends of the lift arms 11 are moved rearward in the first half of the load raising operation and moved forward in the second half. As a result, the path of the front ends (or the pins 38) of the lift arms 11 to which the bucket 7 is mounted will describe a moderate S-shaped curved line that is approximate to a straight vertical line as indicated by reference symbol T in FIG.4. The load lowering operation is performed in the order reverse to the above load raising operation.

In comparison to a case where load raising/lowering operation is performed with a circular path of a lift arm, the forward reach of the lift arm 11 at Its raised position will be considerably lengthened to improve the workability in load handling and to increase the maximum load to be handled.

The skid steer loader 1 of the preferred embodiment has the front links 22, the rear links 21 and the lift cylinders 23 mounted to the frame 2 at the substantially same level. Since the links 21, 22 and the lift cylinders 23 are thus mounted to the robust frame 2 at the same level, a support structure for the lift arms 11 having an improved mechanical strength is realized and the skid steer loader 1 having such a support structure is suitable for use in handling heavy loads. In addition, the arrangement of the front links 22, the rear links 21 and the lift cylinders 23 looks orderly and the design of the raising and lowering device 10 and its surroundings is improved.

The positions at which the front links 22, the rear links 21 and the lift cylinders 23 are connected to the frame 2 are located higher than the upper ends of the front and rear wheels 3, 4 of the skid steer loader 1. Accordingly, the links 21, 22 and the lift cylinders 23 will not interfere with the front and rear wheels 3, 4, with the result that the vehicle may be made compact.

By disposing the paired links 21, 22 and lift cylinders 23 at the same laterally spaced interval as the paired front and rear wheels 3, 4, the front and rear wheels 3, 4 and the lift arms 11 are arranged rationally within the compact width of the vehicle in comparison, for example, to the structure shown in FIG. 6 of the U.S. Pat. No. 6,796,762. Therefore, the skid steer loader I can be made with a compact width and is easy to work in a narrow space. Additionally, the space for the cabin 6 between the lift arms 11 will be widened, especially, in the lateral direction of the vehicle.

In the preferred embodiment, the counterweight 8 is arranged lower than the positions where the front link 22, the rear link 21 and the lift cylinder 23 are connected to the frame 2 and also rearward of the rear wheel 4. Accordingly, the space which has been conventionally regarded as a dead space may be used advantageously for arrangement of the counterweight 8 thereby to achieve a compact vehicle body, and the stability of the vehicle in Its longitudinal direction is effectively improved, so that the vehicle will not tilt forward due to a heavy load raised by the bucket 7.

The connecting position of each front link 22 to the frame 2 is located near the front of the frame 2, and the length La of each rear link 21 is half of the length Lb of each front link 22 or greater. The connecting position of each rear link 21 to the frame 2 is located rearward of the rear axle 4a of the skid steer loader 1. Furthermore, the connecting position of each lift cylinder 23 to the frame 2 is located adjacent to the connecting position of each rear link 21 to the frame 2. Therefore, the above advantageous effects are obtained, the bucket 7 is moved along the vertical path T as shown in FIG. 4, and the long forward reach of the lift arms 11 is ensured at their raised position, thus improving the workability of the vehicle.

The present Invention is not limited to the embodiment described above, but it may be modified into various embodiments as exemplified below.

In the preferred embodiment, the counterweight 8 is arranged within the support 5. However, the counterweight 8 may be disposed outside the box-shaped support 5 or may be arranged one inside and the other outside the frame 5. The same is true of the arrangement of a fuel tank or the oil tank.

In the preferred embodiment, the lift arms 11, the links 21, 22 and the lift cylinders 23 are laterally spaced at substantially the same distance as the front and rear wheels 3, 4. In an alternative embodiment, part of the above components may be arranged otherwise. However, taking the advantages of a compact vehicle body which contributes to easy working in a narrow space and a wide space available for the cabin 6 into consideration, part of the components are preferably arranged at the same spaced interval as the wheels, and, more preferably, all the components are arranged as in the preferred embodiment.

The application of the above-described raising and lowering device 10 is not limited to the skid steer loader 1. It is also applicable to an industrial vehicle having a lift arm whose front end should preferably be raised and lowered in a vertical path.

Therefore, the present examples and embodiments are to be considered as illustrative and not restrictive, and the invention is not to be limited to the details given herein but may be modified within the scope of the appended claims.

What is claimed is:

1. An industrial vehicle comprising:
a frame;
a lift arm having a front end;
a working implement mounted to the front end of the lift arm;
a front link pivotally connected at one end to the lift arm and at the other end to the frame at a first connecting position;
a rear link pivotally connected at one end to the lift arm and at the other end to the frame at a second connecting position; and
a lift cylinder pivotally connected at one end to the lift arm and at the other end to the frame at a third connecting position, wherein the first connecting position, the second connecting position and the third connecting position are located at substantially the same level.

2. The industrial vehicle according to claim 1, wherein the first connecting position, the second connecting position and the third connecting position are located higher than an upper end of a wheel of the industrial vehicle.

3. The industrial vehicle according to claim 1, further comprising:
at least one of a counterweight, a fuel tank, an oil tank and a battery arranged at a position which is lower than the first connecting position, the second connecting position and the third connecting position and rearward of a rear wheel of the industrial vehicle.

4. The industrial vehicle according to claim 1, wherein the first connecting position is located around a front of the frame, wherein a length of the rear link is half of a length of the front link or greater, and wherein the second connecting position is located rearward of a rear axle of the Industrial vehicle.

5. The industrial vehicle according to claim 1, wherein the third connecting position is located adjacent to the second connecting position.

6. The industrial vehicle according to claim 1, wherein the industrial vehicle is a skid steer loader.

7. The industrial vehicle according to claim 1, wherein a pair of the lift arms, a pair of the front links, a pair of the rear links and a pair of the lift cylinders are provided on opposite sides of the industrial vehicle and spaced laterally at substantially the same distance as a pair of wheels of the Industrial vehicle.

8. The industrial vehicle according to claim 1, wherein the lift arm has a downward extending portion which is formed adjacent to a proximal end of the lift arm, and wherein the front link is pivotally connected at the one end to an end of the downward extending portion.

9. The industrial vehicle according to claim 8, wherein the lift cylinder is pivotally connected at the one end to the lift arm at a position adjacent to a proximal portion of the downward extending portion.

10. The industrial vehicle according to claim 1, wherein the rear link is pivotally connected at the one end to a proximal end of the lift arm.
